(19) United States
(12) Patent Application Publication
(10) Pub. No.: US 2025/0335814 A1
(43) Pub. Date: Oct. 30, 2025

(54) COUNTERFACTUALS GENERATION USING PROBABILITY DISTANCE

(71) Applicant: Intuit Inc., Mountain View, CA (US)

(72) Inventor: Yair HORESH, Kfar-Saba (IL)

(73) Assignee: Intuit Inc., Mountain View, CA (US)

(21) Appl. No.: 18/649,027

(22) Filed: Apr. 29, 2024

(51) Int. Cl. G06N 20/00

(52) U.S. Cl. CPC G06N 20/00

(57) ABSTRACT

A method includes obtaining a first input instance and a first class corresponding to the first input instance, from an input instance dataset. The method further includes calculating a probability distance score based on a set of probability values by a distance function generator to transform the first input instance. The method further includes processing the first input instance and the probability distance score by a counterfactuals generator to generate a counterfactual instance. The method further includes executing a machine learning model to process the counterfactual instance and assign a second class, different from the first class, to the counterfactual instance.

### BACKGROUND

Machine learning models play a vital role in numerous data-driven screening applications. Users are often denied loans, insurance, access to certain types of healthcare, or fail to qualify for university admissions screening, military eligibility screening, and the like based on personal, financial, or criminal record data processed by machine learning models. It is outside the purview of users to gain a precise understanding of the workings of the machine learning model in question to pinpoint when and how an outcome considered to be adverse is generated. Likewise, it is not feasible for developers to work through a root-cause analysis to determine faults in training, feedback learning or implicit bias of a machine learning model, due to the scale and complexity of extant machine learning models. Therefore, users and developers of machine learning models need to gain insight into the minimal actionable changes that may be made to particular aspects of input data to cause a machine learning model processing the data to generate an outcome that is considered favorable by the user.

### SUMMARY

In general, in one aspect, one or more embodiments relate to a method. The method includes obtaining a first input instance and a first class corresponding to the first input instance from an input instance dataset. The method further includes calculating a probability distance score, based on a set of probability values, to transform the first input instance by a distance function generator executing on a computer processor. The method further includes processing the first input instance and the probability distance score to generate a counterfactual instance by a counterfactuals generator executing on the computer processor. The method further includes executing a machine learning model on the computer processor to assign a second class to the counterfactual instance by processing the counterfactual instance, such that the second class is different from the first class.

In general, in one aspect, one or more embodiments relate to a system. The system includes a server computing system. The server computing system includes a computer processor, a data repository, a distance function generator executing on the computer processor and communicatively coupled to the data repository, and a counterfactuals generator executing on the computer processor and communicatively coupled to the data repository. The server computing system is configured to obtain a first input instance and a first class corresponding to the first input instance from an input instance dataset. The server computing system is further configured to calculate a probability distance score, based on a set of probability values, to transform the first input instance by the distance function generator. The server computing system is further configured to process the first input instance and the probability distance score by the counterfactuals generator to generate a counterfactual instance. The server computing system is further configured to execute a machine learning model on the computer processor, to assign a second class to the counterfactual instance by processing the counterfactual instance, such that the second class is different from the first class.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2, FIG. 3, FIG. 4, and FIG. 5 show flowcharts of a method, in accordance with one or more embodiments.

FIG. 6 shows examples of an input instance dataset, with different feature categories, each feature category including one or more feature values, in accordance with one or more embodiments.

FIG. 7 shows an example of calculating a conditional probability ratio, in accordance with one or more embodiments.

FIG. 8A and FIG. 8B show a computing system in accordance with one or more embodiments of the invention.

Like elements in the various figures are denoted by like reference numerals for consistency.

### DETAILED DESCRIPTION

One or more embodiments are directed to generation of counterfactuals for machine learning models. As a general overview, a counterfactual is the minimal change to a fact pattern, or input instance, which, when processed by a machine learning model, will produce an outcome that is different to the outcome generated by processing the original fact pattern or input instance. A fact pattern is a collection of particular facts pertaining to a user, for example, name, age, income, etc. In the context of a machine learning model, a fact pattern is an input instance to the machine learning model.

Counterfactuals are used in the evaluation and detection of implicit bias of a machine learning model. A bias of a machine learning model pertains to undue importance or influence given to certain aspects of input data during training of the machine learning model that result in skewed or prejudicial outcomes when the machine learning model is used in runtime on datasets that lack the thresholds of those aspects. Thus, when a machine learning model processes counterfactuals including alterations to those aspects, the resulting altered outcomes afford insight and improved explainability of the machine learning model. Explainability of a machine learning model refers to human understanding of how a machine learning model produces an outcome by processing a particular fact pattern or input instance.

Counterfactuals include dependencies on the datatypes present in the dataset of input instances. For example, an input instance may include numerical data, such as age, income, height, textual data such as name, address, etc. An input instance may also include categorical data, for example, make and model of vehicle, gender of an individual, health risk factors such as diabetes, hypertension, pregnancy, and the like. Categorical data pertains to data which does not have a naturally characterizable order. For example, the color of a vehicle, such as red, blue, black, etc., does not have a characterizable natural order, compared to numerical data such as age, income etc., or alphabetizable textual data such as names, addresses, etc. The lack of a characterizable natural order impacts the determination of thresholds of factors of a categorical data type in the input instance that may alter an adverse or unfavorable outcome to a favorable outcome when processed by the machine learning model. Moreover, real-world dependencies or mutual exclusions between a categorical data type and other data types, numerical, text, or categorical, do not lend to an intuitive characterization. For example, if an input instance has an age value of 80, then the corresponding health risk factor value should preclude the condition “pregnant”. Consequently, a generated counterfactual instance including this combination of values, i.e., age is 80 and health risk factor is “pregnant”, is not a realistic instance that may be used in further evaluation of the machine learning model.

Some terms and their definitions as used within the scope of this description are presented herein. The input to a machine learning (ML) model includes data of various, distinct types, for example, numerical, natural language, image, categorical, and the like. The input data includes one or more features. A feature represents an individual measurable property or characteristic of the input data. Features are the input variables to ML models. For example, the features of the input data may include name, age, height, weight, gender, health risk factor, etc. A feature may have one or more values.

A feature value is the actual measurement or value corresponding to a specific feature for a specific data point. Generally speaking, feature values corresponding to a feature fall into a specific, permissible range. For example, the age of a person cannot exceed 125 years, the height of a person cannot exceed fifteen feet or be less than one foot, etc. The feature value may have a specific data type, for example, numerical, categorical, alphanumerical, etc. As described herein, features of various non-categorical data types are convertible to categorical features. For example, a numerical feature such as age may be convertible to an age group category. Therefore, the terms “feature category” and “feature” are interchangeably used in the detailed description to refer to the features of input data. Likewise, the terms “set of feature categories” and “feature category set” are used interchangeably in the detailed description to refer to the set of features of input data, as also “subset of feature categories” and “feature category subset”.

An input instance is a set of feature values corresponding to a specific data point. For example, an input instance of input data characterized by feature categories {name, age, height, weight, biological sex, health risk factor}, is the specific data point represented by the vector, or the set {John Doe, 60-65, 180-200, 200-220, Male, hypertension}. The feature values are the elements of the set. The terms “feature value” and “categorical feature value” are used interchangeably in the detailed description. Again, similar to feature categories, the terms “feature value subset” and “subset of feature values” are used interchangeably in the detailed description and refer to a subset of feature values of an input instance. Further, the terms “set of feature values” and “feature value set” are used interchangeably in the current specification and refer to the set of feature values of an input instance.

In the context of counterfactuals, the class of an input instance refers to the predicted outcome or label assigned by the machine learning model processing the input instance to that specific instance. For example, the machine learning model may be a binary classification model for loan application screening that assigns the labels, or classes, “accepted” or “rejected” to an input instance representing an applicant's financial data. Accordingly, the counterfactual instance corresponding to the input instance may be a modified copy of the input instance, the modifications to the feature values causing the machine learning model to change the class of the counterfactual instance from “rejected” to “accepted.” In other words, if an input instance processed by a machine learning model is assigned to a particular class signifying an adverse outcome, a counterfactual instance corresponding to the input instance, when processed by the machine learning model, is assigned a different class, signifying a favorable outcome. Notably, in the opposite case, an input instance may be classified by a machine learning model to a favorable class. Accordingly, the counterfactual instance corresponding to the input instance would, when processed by the machine learning model, be classified to an unfavorable class. The terms “class” and “outcome class” are used interchangeably in the current specification and refer to the predicted outcome or label assigned by a machine learning model processing an input instance to that specific input instance.

The set of all input instances of the input data processed by the machine learning model and assigned corresponding classes is an input instance dataset. An input instance dataset, therefore, corresponds to a particular application executing a machine learning model. By way of a first example, a loan approval screening application executing a machine learning model trained to approve or deny loan applications by customers may include an input instance dataset with input instances and corresponding classes (either “approved” or “denied”). In a second example, a military eligibility screening application executing a different machine learning model trained to approve or deny an applicant to sign up as a military recruit may include a different input instance dataset from the first example.

A snapshot is a version of an input instance dataset corresponding to a particular timestamp. For example, a first snapshot of the input instance dataset of insurance customers corresponding to the beginning of a calendar year, may be stored in a data repository. A second snapshot of the input instance dataset of insurance customers corresponding to the subsequent calendar year may be stored, separately from the first snapshot, in the data repository. Subsequently, the first and second snapshots of the input instance dataset may be used for further analysis.

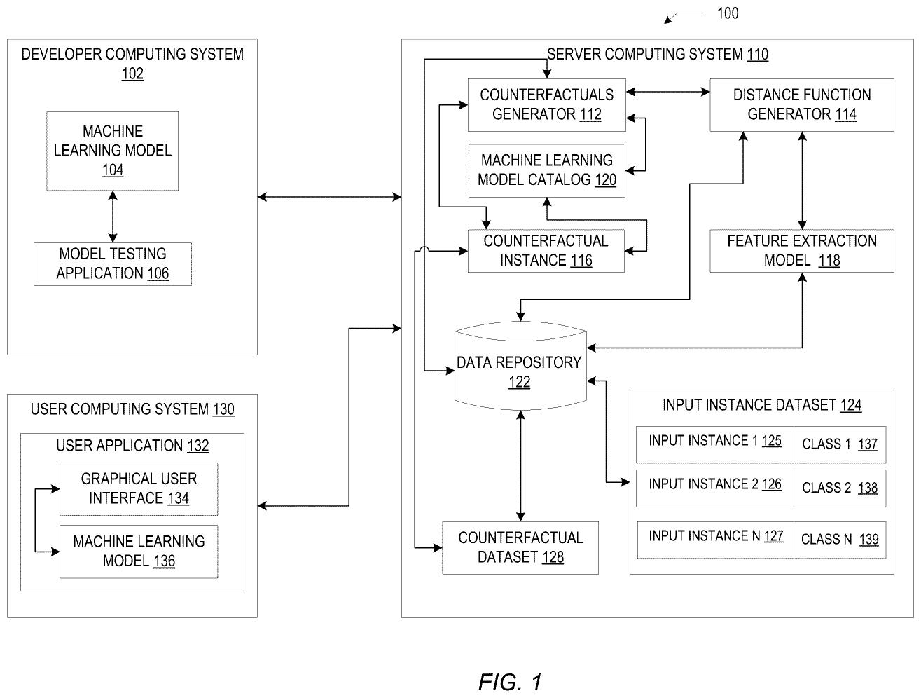

Attention is now turned to the figures. FIG. 1 shows a system 100 in accordance with one or more embodiments. The system 100 includes a server computing system (110), communicatively coupled to one or more of a user computing system (130) and a developer computing system (102). Each of these systems and necessary components are described herein.

The system 100 shown in FIG. 1 includes a server computing system (110). The server computing system (110) further includes a data repository (122), a counterfactuals generator (112), a distance function generator (114), a feature extraction model (118), and a machine learning model catalog (120). Each of these components is further described below.

The data repository (122) is a type of storage unit or device (e.g., a file system, database, data structure, or any other storage mechanism) for storing data. The data repository (122) may include multiple different, potentially heterogeneous, storage units and/or devices. The data repository (122) includes multiple input instance datasets (124). The input instance dataset (124) includes multiple input instances, shown as input instance 1 (125), input instance 2 (126), and input instance N (127). Each input instance has a corresponding class, shown as class 1 (137), class 2 (138) and class N (139) respectively. The input instance dataset (124) corresponds to a particular application. Notably, the input instances of input instance dataset (124) include a common set of feature categories. For example, the input instance dataset (124) may include input instances for applications pertaining to health insurance qualification screening. Accordingly, the input instances may include data characterized by the feature categories {name, age, height, weight, biological sex, health risk factors}. An input instance includes categorical feature values corresponding to the feature categories. The data repository (122) may include several types of input instance datasets corresponding to different applications, for example, home improvement loan screening, student grant application screening, and the like, wherein an input instance dataset corresponding to a particular application includes input instances having feature values corresponding to feature categories pertaining to the particular application.

The data repository (122) further includes one or more counterfactual datasets (128). The counterfactual dataset (128) includes multiple counterfactual instances (116). The counterfactual instance (116) may be generated by the counterfactuals generator (112) in the server computing system (110) in response to a request originating from the user computing system (130) or the developer computing system (102). Similar to the input instance dataset, the counterfactual dataset (128) corresponds to one or more machine learning models executed by a user application (132) on the user computing system (130) or the developer computing system (102). Accordingly, the data repository (122) includes multiple counterfactual datasets corresponding to different applications executing on the user computing system (130) and the developer computing system (102). Similar to an input instance, the counterfactual instance (116) is a set of feature values corresponding to a specific data point. Notably, a counterfactual instance is generated based on a particular input instance. For example, an input instance to a military eligibility application may include an age value of 15, potentially causing an unfavorable classification by the machine learning model executing within the military eligibility application. A counterfactual instance generated based on the input instance may be a minimally modified copy of the input instance, for example, with only the age value altered to 18, leaving the rest of the feature values of the input instance un-altered, potentially reversing the unfavorable classification by the military eligibility application.

The server computing system (110) further includes a feature extraction model (118). The feature extraction model (118) is communicatively and operatively coupled to the data repository (122) and the distance function generator (114). The feature extraction model (118) is a collection of programs and code including functionality to characterize an input instance dataset into multiple features. Further, the feature extraction model (118) includes functionality to convert features of numerical or other non-categorical data types to feature categories. For example, an age feature may be converted to an age category feature. In like manner, an address feature may be converted to a location category feature, for example, urban, suburban, or rural. The feature extraction model (118) may include multiple techniques to characterize diverse types of input data, for example, principal component analysis for image data, word embeddings for natural language data, binning or discretization for numerical data, and feature hashing for converting categorical variables into numerical features.

The server computing system (110) further includes a distance function generator (114). The distance function generator (114) is communicatively and operatively coupled to the feature extraction model (118), the counterfactuals generator (112), and the data repository (122). The distance function generator (114) is a collection of computer-executable code and programs including functionality to calculate a probability distance score. The probability distance score is used as a transform function by the counterfactuals generator (112) to generate a counterfactual instance (116) based on an input instance. The probability distance score is a quantification of the alterations to the feature values of the input instance to transition the class of the input instance to the class of the counterfactual instance. Examples of distance scores hitherto used for different feature datatypes include Euclidean, Manhattan, or Minkowski distance scores for numeric, continuous features, Hamming distance for binary features, Cosine similarity for feature vectors, and the like. The probability distance score calculated by the distance function generator is described in further detail in reference to FIG. 3.

The server computing system (110) further includes a counterfactuals generator (112). The counterfactuals generator (112) is operatively and communicatively coupled to the distance function generator (114), the data repository (122), and a machine learning model catalog (120). The counterfactuals generator (112) included in the server computing system is a machine learning model including functionality to generate a counterfactual instance based on an input instance and a distance score. As a general overview, the objective of a counterfactuals generator is to find minimal changes to an input instance that alter the original predicted class of the input instance when processed by a machine learning model. To this end, the counterfactual generator uses a distance score, as described hereinabove, that includes a term that measures a distance between the original input instance and the modified counterfactual instance. The counterfactuals generation process further requires compliance with plausibility and actionability constraints. Examples of model-agnostic (without relying on knowledge of the specifics of the machine learning models for which counterfactuals are being generated) counterfactual generators include DiCE (DIverse Counterfactual Explanations), a library that generates counterfactuals for individual instances, and works with various ML models, LIME (Local Interpretable Model-agnostic Explanations), and the like. Examples of domain-specific counterfactual generator models include Polyjuice for natural language processing (NLP) models, CouRGe, a counterfactuals generator for sentiment analysis, healthcare specific models, and the like.

The machine learning model catalog (120) of the server computing system includes multiple machine learning models corresponding to one or more of the machine learning models (104) executing on the developer computing system (102), or the machine learning model (136) of the user application (132) executing on the user computing system (130). A catalog is an inventory or library of independently executable computer programs, or software functions, organized for improved access, usage, and maintainability. The machine learning model catalog (120) is communicatively and operatively coupled to the counterfactuals generator (112). In one embodiment, the counterfactuals generator uses a machine learning model obtained from the machine learning model catalog (120) to process the generated counterfactual instance. The machine learning model obtained from the machine learning model catalog corresponds to the machine learning model that previously processed the input instance and assigned a class to the input instance. Accordingly, the counterfactuals generator may verify that the machine learning model assigns a different class to the counterfactual instance than the class assigned to the input instance.

The system 100 further includes a developer computer system (102). The developer computing system (102) is communicatively coupled to the server computing system. The developer computer system (102) includes multiple machine learning models (104) and model testing applications (106). In one embodiment, a machine learning model developer uses the developer computer system (102) to train and evaluate the machine learning models (104) used in multiple real-world applications, for example, leasing requests, disease prediction, job applications, credit scoring, university admissions, and the like. The developer computer system (102) may include multiple model testing applications (106). The model testing applications (106) train, test, and evaluate the machine learning models (104) for explainability, robustness and causality, and fairness and data augmentation based on various metrics such as accuracy, F1-score or mean squared error. In one or more embodiments, requests to generate counterfactual instances directed to the server computing system may originate from a developer via the developer computing system (102) and model testing application (106).

The system 100 further includes a user computing system (130). The user computing system (130) is communicatively coupled to the server computing system. The user computing system (130) includes multiple user applications (132). The multiple user applications (132) executing on the user computing system (130) include the real-world application examples previously described. In one or more embodiments, a user application (132) may include a machine learning model (136) and a graphical user interface (134). The user interacts with the machine learning model (136) via graphical artifacts presented to the user by the graphical user interface (134). In one embodiment, a request to generate counterfactual instances directed to the server computing system may originate from a user via the user computing system (130) and user application (132).

While FIG. 1 shows a configuration of components, other configurations may be used without departing from the scope of one or more embodiments. For example, various components may be combined to create a single component. As another example, the functionality performed by a single component may be performed by two or more components.

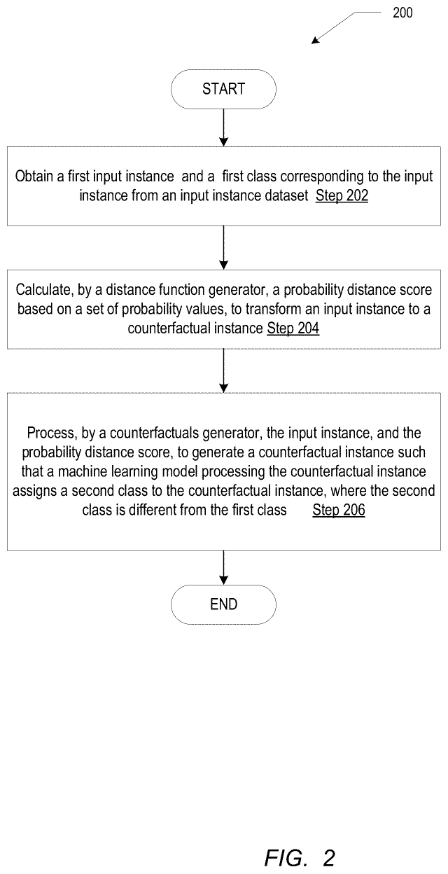

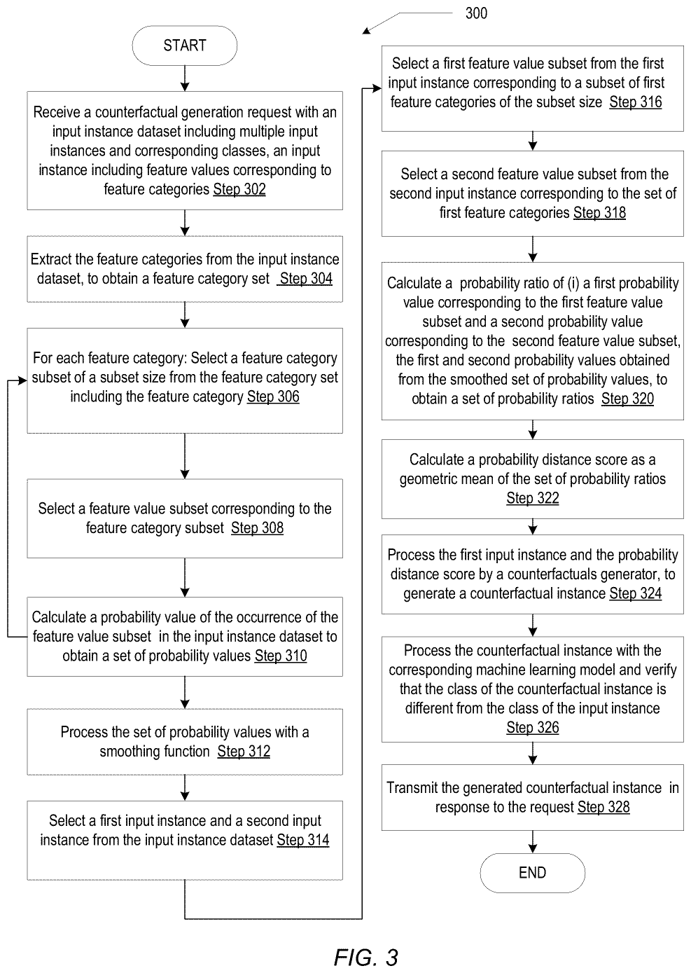

FIGS. 2-5 show flowcharts of various methods in accordance with one or more embodiments. While the various steps in the flowcharts are presented and described sequentially, at least some of the steps may be executed in different orders, may be combined, or omitted, and at least some of the steps may be executed in parallel, or iteratively. Furthermore, the steps may be performed actively or passively.

Turning now to FIG. 2, a method (200) for generating a counterfactual instance based on a probability distance score is presented in accordance with one or more embodiments. The method (200) is described in reference to the components of FIG. 1. In one embodiment, various steps of the method (200) are performed by components of the server computing system.

The method (200) starts at step 202. A first input instance is obtained from an input instance dataset. Additionally, a first class corresponding to the input instance is obtained. In one embodiment, the first input instance originates from a user application executing on a user computing system. A user enters data in accordance with the instructions or requirements displayed in the graphical user interface component of the user application. The data collected from the user constitutes the input instance. In one embodiment, the first input instance is processed by a machine learning model executing within the user application and is assigned a corresponding outcome class. In one or more embodiments, the user application may further include functionality to present the user with the result of the machine learning model processing the first input instance, with options to change various aspects of the input instance to obtain a different outcome class. Subsequently, the user application may send a request for a counterfactual instance corresponding to the first input instance to the server computing system. In one or more embodiments, the request for a counterfactual instance may originate from a model testing application executing on a developer computing system. The model testing application may transmit a request for a counterfactual instance to the server computing system.

At step 204, a probability distance score to transform the first input instance to a counterfactual instance is calculated, based on a set of probability values. In one embodiment, the distance function generator calculates the probability distance score. The steps of calculating the probability distance score are described in more detail in reference to FIG. 3.

At step 206, the first input instance and probability distance score are processed by the counterfactuals generator to generate a counterfactual instance, such that a machine learning model processing the counterfactual instance assigns a second class corresponding to the counterfactual instance, and the second class is different from the first class. In one embodiment, the probability distance score and input instance are provided as parameters to the counterfactuals generator and the counterfactuals generator generates a counterfactual instance from the input instance based on the probability distance score. Subsequently, the counterfactual instance is processed by a machine learning model selected from the machine learning model catalog and is assigned an outcome class. The outcome class corresponding to the counterfactual instance is compared to the outcome class corresponding to the input instance to verify that they are different. The machine learning model selected by the counterfactuals generator is the same as the machine learning model that previously processed the input instance and assigned an outcome class to the input instance. In one or more embodiments, the server computing system may include functionality to obtain information about the specific machine learning model from the input instance dataset corresponding to the specific application generating the input instance. By way of example, the input instance may be part of an input instance dataset corresponding to a user application for credit score appraisal, and the corresponding machine learning model is selected from the machine learning model catalog. The method (200) ends at step 206.

Turning now to FIG. 3, a method (300) for calculating a probability distance score from an input instance dataset and generating a counterfactual instance based on the probability distance score is presented, in accordance with one or more embodiments. The steps of the method (300) are described in reference to the system components shown in FIG. 1. In one or more embodiments, various steps of the method (300) are performed by the feature extraction model, the distance function generator, and the counterfactuals generator of the server computing system.

The method (300) starts at step 302. A request for counterfactuals generation is received by the server computing system. The request includes an input instance dataset. The input instance dataset includes multiple input instances and corresponding outcome classes assigned to the input instances by a machine learning model processing the input instances of the input instance dataset. An input instance further includes multiple categorical feature values representing a specific data point (for example, a user's data). In one embodiment, the machine learning model is a component of a user application executing on a user computing system. In another embodiment, the machine learning model may be a component of a model testing application executing on a developer computing system. At step 304, the input instance dataset is processed to extract the feature categories corresponding to the input instance dataset, to obtain a feature category set. In one embodiment, the feature extraction model executing on the server computing system performs step 304. Notably, the feature extraction model converts non-categorical features, for example, numerical features such as age, income, height, weight, and the like, into categorical features, for example, age group, income group, and the like.

In one or more embodiments, Steps 306, 308 and 310 of method 300 are performed iteratively for each feature category of the input dataset. At step 306, a subset of feature categories of a subset size is selected. Further, the subset of feature categories includes the feature category for the current iteration being performed. The size of the subset must be at least 1 and may not be greater than the cardinality of the set of feature categories corresponding to the input instance dataset. In one embodiment, the size of the subset may be included in the counterfactuals generation request from step 302.

The subset size indicates the number of feature categories that will be considered together when calculating the probability values of the joint occurrence of the features. For example, if the total number of feature categories is 5, selecting a subset size of 1 entails the calculation of the probability of the values corresponding to each distinct feature category in relation to the values corresponding to the remaining feature categories. In another example, selecting a subset size of 2 entails calculating the probability of the values of all combinations of two feature categories in relation to the values corresponding to the remaining feature categories. Selecting a larger subset size models the real-world relationships between the feature categories more accurately, and potentially can lead to better counterfactuals generation. However, a repercussion of selecting a larger subset size is that the probability values calculated for instances corresponding to a larger subset sizes diminish rapidly. For example, there may be many instances of Ford owners, but significantly fewer instances of Ford owners who own white Fords, and even further fewer instances of Ford owners in the age group of 20-25 who own white Fords.

At step 308, a feature value subset corresponding to the subset of feature categories is selected. By way of example, the set of feature categories may include {name, age, vehicle type, vehicle color, vehicle make, gender}. The selected feature category for the current iteration may be “vehicle color.” The subset size may be set to three. Accordingly, a subset of three elements from the set of feature categories including the first feature category may be selected. For example, the subset of feature categories may be {name, age group, vehicle color} or {age group, vehicle make, vehicle color}. The corresponding feature value subsets may be {Jane Doe, 40-45, Red}, {40-45, Toyota, White}.

At step 310, a probability value of the occurrence of the feature value subset selected in step 308 in the input instance dataset is calculated. In one embodiment, the probability value is calculated in accordance with Equation 1:

$$P ( feature value subset ) = \frac{Occurrences of feature value subset}{Total number of input instances} \qquad ( 1 )$$

In Equation 1, P (feature value subset) is the probability of the occurrence of the feature value subset in the input instance dataset and is set to the number of times the feature value subset occurs in the input instances of the input instance dataset divided with the total number of input instances in the input instance dataset. By way of example, if the feature value subset {40-45, Toyota, White} occurs 50 times in the input instance dataset and the input instance dataset has 250 input instances, then P (40-45, Toyota, White) is ⅕. Notably, the feature value subset includes a feature value corresponding to the selected feature category for the current iteration. Further, the probability values corresponding to the feature value subset are calculated for each feature value corresponding to the selected feature category. By way of example, if “vehicle color” is the selected feature category, and “vehicle color” has a set of possible feature values {Red, Blue, White}, then probability values for all feature value subsets including “Red,” “Blue” and “White” occurring in the input instance dataset are calculated in the current iteration.

At Step 312, the set of probability values is processed with a smoothing function to obtain a set of smoothed probability values. In one embodiment, the distance function generator performs step 312 of the method 300. Some examples of smoothing functions used to process the set of probability values are Laplace smoothing function, Kneser Key smoothing function, and the like.

At Step 314, a first and second input instance are selected from the input instance dataset. Steps 316, 318 and 320 of the method 300 are intermediate steps performed on the first and second input instances from Step 314 to calculate the probability distance score. The probability distance score is the probability distance of transforming the first instance to the second instance. More specifically, the probability distance score is defined as a geometric mean of the probability ratios of the corresponding probability values of the first and second instance.

At step 316, a first feature value subset is selected from the first input instance. The first feature value subset corresponds to a first subset of feature categories. The subset of feature categories is of the subset size from step 306. For example, the first subset of feature categories may be {vehicle name, vehicle model, vehicle color} and the corresponding feature value subset from the first instance may be {Toyota, Camry, Blue}. At step 318, a second feature value subset is selected from the second input instance. Notably, the second feature value subset corresponds to the first subset of feature categories. For example, the second feature value subset selected from the second input instance may be {Honda, Accord, White}. The feature values from the subset selected from the second input instance correspond to the feature category subset {vehicle name, vehicle model, vehicle color}.

At step 320, a first probability value corresponding to the first feature value subset is obtained from the set of smoothed probability values. In like manner, a second probability value corresponding to the second feature value subset is obtained from the set of smoothed probability values. Subsequently, a probability ratio is calculated. In one embodiment, the probability ratio is calculated in accordance with Equation 2:

$$P {R}_{first \to second} = \frac{P ( first )}{P ( second )} \qquad ( 2 )$$

In Equation 2, PR is the probability ratio of the probability value corresponding to the first feature value subset, P (first), to the probability value corresponding to the second feature value subset, P (second). The probability ratio is added to a set of probability ratios corresponding to the first and second input instances. Probability ratios for all feature value subsets corresponding to all feature category subsets of the subset size are calculated for the first and second input instances to obtain a set of probability ratios for the first and second input instances.

At step 322, the probability distance score is calculated as the geometric mean of the set of probability ratios obtained in step 320. In one embodiment, the probability distance score is calculated in accordance with Equation 3:

$$DS ( {Instance}_{1} \to {Instance}_{2} ) = \sqrt[n]{{\prod }_{1}^{n} {PR}_{i}} \qquad ( 3 )$$

DS is the probability distance score which is the probability distance of transforming the first input instance (Instance₁) to the second input instance (Instance₂). The geometric mean of a set of n values is the n^{th} root of the product of the set of values. Accordingly, PRᵢ is the i^{th} probability ratio of the set of probability ratios, and i varies from 1 to n, n being the cardinality of the set of probability ratios. The product (π_{1»n}) of the n probability ratios of the set of probability ratios is calculated and then the n^{th} root of the product is determined to yield the probability distance score.

At step 324, the first input instance and the calculated probability distance score are processed by the counterfactuals generator to generate a counterfactual instance corresponding to the first input instance. In one embodiment, an additional step of verification shown in step 326 may be performed, where the generated counterfactual instance is processed with a machine learning model selected from the machine learning model catalog. The selected machine learning model corresponds to the machine learning model that previously processed the input instance dataset and assigned outcome classes to the input instances of the input instance dataset. The counterfactual instance is assigned an outcome class by the machine learning model and the outcome classes corresponding to the counterfactual instance and the first input instance respectively are compared to verify that they are different. The method (300) ends after step 324. The counterfactual instance is transmitted to the sender of the request from step 302.

Turning now to FIG. 4, a method (400) for screening the input instance dataset is presented, in accordance with one or more embodiments. The steps of the method 400 are described in reference to the system components shown in FIG. 1. In one or more embodiments, various steps of the method (400) are performed by the feature extraction model, and the distance function generator of the server computing system.

In one embodiment, the method (400) may be performed to screen the input instance dataset for faulty input instances prior to calculating the probability distance score to generate the counterfactual instance. In screening the input instance dataset, input instances with feature values outside the ranges of the corresponding feature categories may be eliminated from the input instance dataset. Moreover, conflicting conditions arising from a combination of feature values corresponding to two or more feature categories may also cause the input instance to be removed from the input instance dataset. For example, a human height value of 25 feet in an input instance may cause the input instance to be removed from the input instance dataset. In an additional example, if an input instance has an age group value of “80-85” and a health condition risk factor value of “pregnant”, the input instance may be eliminated from the input instance dataset. In the context of the input instance dataset, faulty input instances are presumed to have a low occurrence due to functionality that may be included in a user application or model testing application to flag erroneous data entry from a user and/or developer. Accordingly, a set of probability values are calculated for multiple feature value subsets corresponding to multiple feature category subsets of a subset size selected from a candidate input instance. An instance probability score is calculated from the set of probability values obtained for the candidate input instance. If the instance probability score is less than an instance probability threshold, then the candidate input instance is eliminated from the input instance dataset.

Accordingly, the method (400) starts at step 402. A set of feature categories is obtained from the input instance dataset. In one embodiment, the feature extraction model performs step 402 of the method (400). At step 404, a candidate input instance is selected for screening from the input instance dataset. In one or more embodiments, steps 404-418 are iterated for the input instances of the input instance dataset.

In one embodiment, steps 406-410 of the method (400) are iterated for multiple feature categories of the feature category set. Accordingly, at step 406, a feature category subset of a subset size is selected from the set of feature categories obtained in step 402. Further, the feature category subset includes a selected feature category for the current iteration. As described in reference to the method 300, the subset size is a significant factor. At step 408, a candidate feature value subset corresponding to the feature category subset is selected from the candidate input instance. At step 410, the probability value of the occurrence of the candidate feature value subset in the input instance dataset is calculated and added to a set of candidate probability values.

At step 412, the set of candidate probability values obtained from multiple iterations of steps 406-410 is smoothed with a smoothing function. At step 414, an instance probability score is calculated. The instance probability score is defined as the geometric mean of the set of candidate probability values. At step 416, the instance probability score is compared to an instance score threshold, and if the instance probability score is less than the instance score threshold, then the input instance is eliminated, or removed, from the input instance dataset, as shown in step 418. The method (400) ends when the input instances of the input instance dataset are screened.

Turning now to FIG. 5, a method of calculating a conditional probability distance score based on the change of an input instance between a first and second snapshot of the input instance dataset is presented. The method (500) is described in reference to the components of FIG. 1. In one or more embodiments, various steps of the method (500) are performed by the distance function generator, and the counterfactuals generator.

As described hereinabove, a snapshot is a version of an artifact corresponding to a specific timestamp. In the context of the input instance dataset, a snapshot of the input instance dataset is a version of the input instance dataset corresponding to a specific timestamp, for example, the beginning of the previous calendar year. The version is stored in the data repository without any further incremental changes to the input instance dataset. Any subsequent additions, modifications or deletions to the input instance dataset may be made to a different copy of the input instance dataset.

Accordingly, at step 502 of the method (500), a first snapshot and a second snapshot of the input instance dataset are obtained, corresponding to a first and second timestamp, respectively. Further, the first timestamp is prior to the second timestamp. At step 504, a previous input instance is selected from the first snapshot and a next input instance is selected from the second snapshot.

In one or more embodiments, steps 506-514 of the method (500) may be iterated to obtain a set of conditional probabilities, for the feature categories from a feature category set corresponding to the input instance dataset. A conditional probability is defined as the probability of a previous input instance from the first snapshot transforming to a next input instance from the second snapshot. More specifically, the conditional probability is a ratio of the probability of an occurrence of the previous input instance in the first snapshot and the probability of an occurrence of the next input instance in the second snapshot. As described herein in reference to method (300), a probability value of an occurrence of an input instance in an input instance dataset further encompasses calculating the probabilities corresponding to occurrences of feature value subsets of the input instance in the input instance dataset. Thus, the set of conditional probabilities encompasses ratios of probability values of feature value subsets of the previous input instance in the first snapshot and probability values of corresponding feature value subsets of the next input instance in the second snapshot.

Accordingly, probability values for feature value subsets of the previous input instance and corresponding feature value subsets of the next input instance are calculated. At step 506, a feature category subset of a subset size is selected from the feature category set corresponding to the input instance dataset. In one or more embodiments, the method (500) includes one or more additional steps (not shown) to extract the feature categories from the input instance dataset to obtain a feature category set. Further, the feature category subset includes a feature category selected for a current iteration of steps 506-514. At step 508, a previous feature value subset is selected from the previous input instance and a next feature value subset is selected from the next input instance. Both the previous feature value subset and the next feature value subset correspond to the feature category subset selected in step 506. In other words, the feature values of both the previous feature value subset and the next feature value subsets correspond to the feature categories of the feature category subset.

Subsequently, in steps 510 and 512, a previous probability value and a next probability value corresponding to the occurrences of the previous feature value subset and the next feature value subset in the first and second snapshot respectively are calculated.

At step 514, a set of conditional probabilities is calculated. In one embodiment, for an iteration of steps 506-514, a ratio of the previous probability value and the next probability value. The resulting ratio is added to the set of conditional probabilities.

At step 516, a conditional probability distance score is calculated. The conditional probability distance score is the probability distance of transforming the previous input instance to the next input instance. The conditional probability distance score is defined as the geometric mean of the set of conditional probabilities.

At step 518, the previous input instance is processed with the conditional probability distance score by the counterfactuals generator to generate a counterfactual instance. The method (500) ends at step 518.

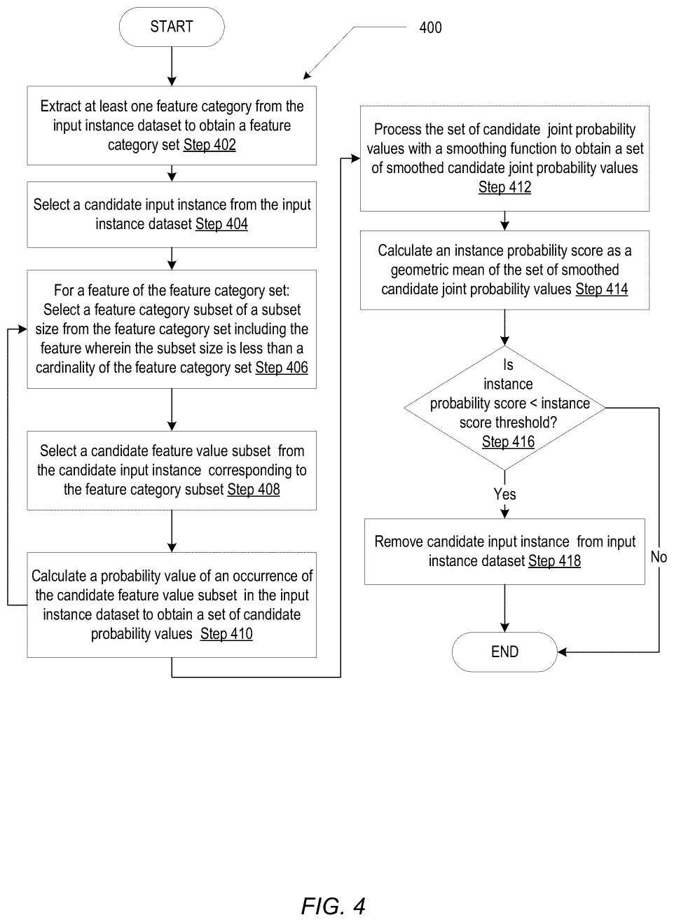

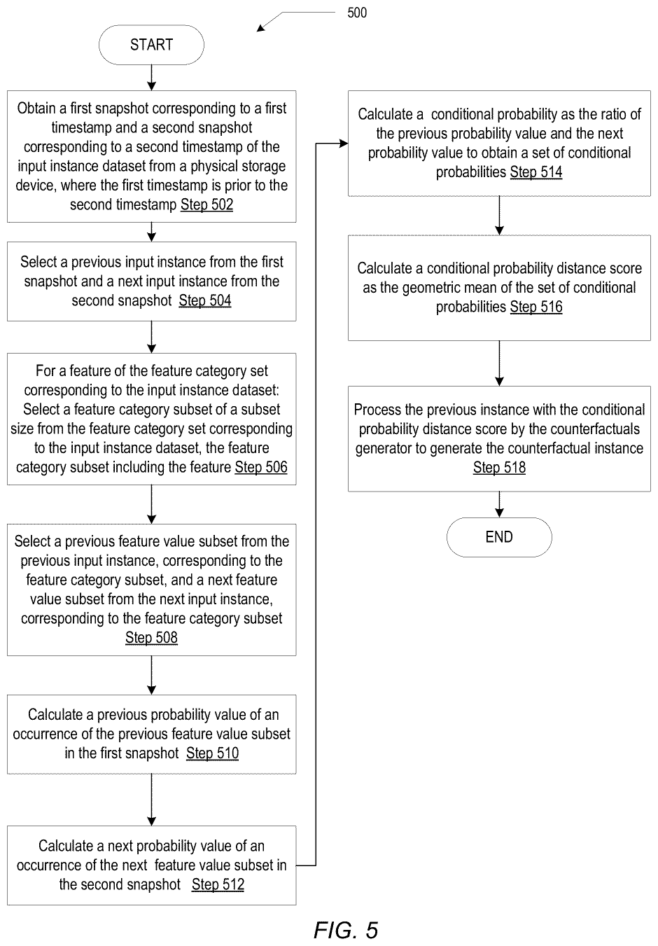

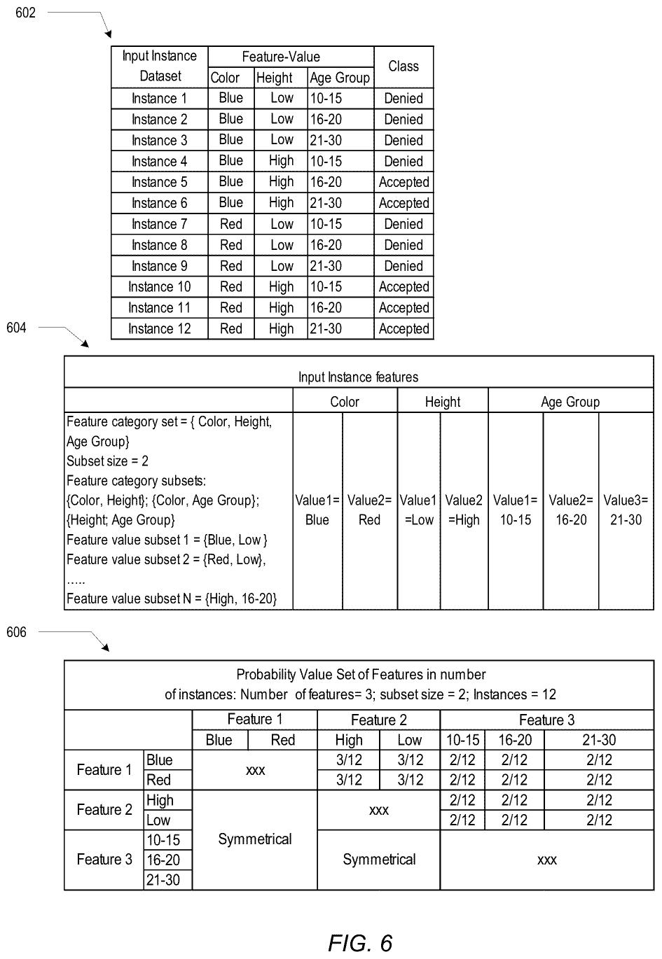

FIG. 6 shows examples of, input instances and probability value, in accordance with one or more embodiments. The examples of FIG. 6 are for explanatory purposes only and not intended to limit the scope of one or more embodiments.

In FIG. 6, table 602 shows an input instance dataset. The input instance dataset includes input instances and assigned classes. The input instance dataset includes three feature categories, namely, Color, Height, and Age Group. The column titled “Class” shows the outcome class assigned to each input instance processed by a machine learning model.

Table 604 shows feature categories and corresponding feature values extracted from the input instance dataset shown in table 602. The feature category set includes three feature categories, namely {Color, Height, Age Group}. Table 604 further shows the possible feature category subsets of subset size=2, namely, {Color, Height}, {Color, Age Group}, and {Age Group, Height}. Accordingly, multiple feature value subsets may be selected corresponding to the feature category subsets, shown as feature value subset 1, feature value subset 2, etc. Notably, the feature value subsets include values corresponding to a specific feature category subset. For instance, feature value subset 1 and feature value subset 2 are feature value subsets corresponding to the feature category subset {Color, Height}. Similarly, feature value subset N is a feature value subset corresponding to the feature category subset {Height, Age Group}.

Table 606 shows the set of probability values calculated for feature value subsets of subset size 2 corresponding to the feature category subsets shown in table 604. Notably, probability values are not duplicated in the set. For example, the probability of the occurrence of feature value subset 1 shown in table 604 in the input instance dataset of table 602 is 3/12. Similarly, the probability of the occurrence of feature value subset 2 in the input instance dataset of table 602 is 3/12. The probability of the occurrence of feature value subset 1 shown in table 604 in the input instance dataset of table 602 is 2/12.

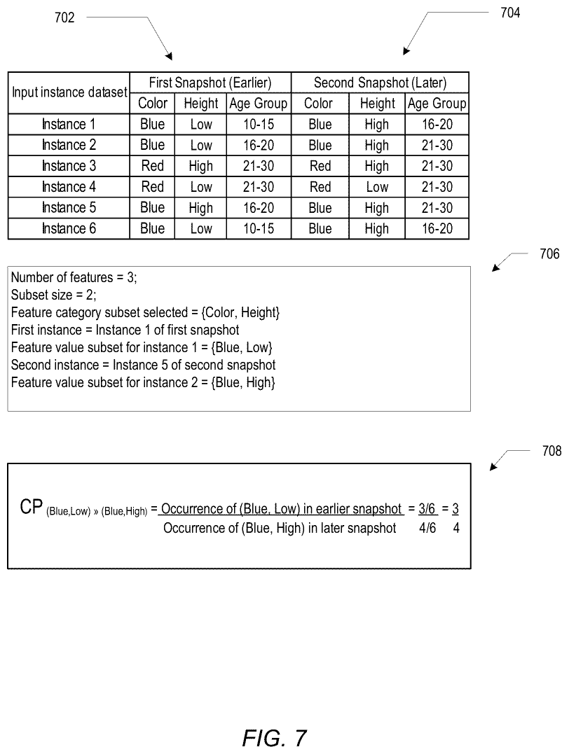

Turning to FIG. 7, an example of a calculation of a conditional probability ratio is shown. The examples of FIG. 7 are for explanatory purposes only and not intended to limit the scope of one or more embodiments.

Table 702 shows a first snapshot of an input instance dataset. Table 704 shows a second snapshot of the input instance dataset. The first snapshot and second snapshot are taken at different timestamps. For instance, the first snapshot may be taken one or two calendar years earlier than the second snapshot. The differences in the age group value corresponding to Instance 1 between the first snapshot and the second snapshot may indicate that one or two calendar years have elapsed between the first and second snapshots. Block 706 shows certain parameters for the calculation of the conditional probability ratio. The number of features in the input instance dataset is set to 3 and the subset size for the feature category subsets corresponding to the input instance dataset is set to 2. In the example, the specific feature category subset that is selected is {Color, Height}. The two selected input instances are instance 1 from the first snapshot, and instance 6 from the second snapshot.

The conditional probability ratio calculated in Block 708 is the probability ratio of a feature value subset corresponding to a first input instance from the first snapshot, namely, instance 1, to a corresponding feature value subset of a second input instance from the second snapshot, namely, instance 6. The example shows a conditional probability ratio of one feature value subset of the first and second instance, respectively. The feature value subsets correspond to the feature category subset selected in Block 706, namely {Color, Height}. Accordingly, the feature value subset for instance 1 in the calculation is {Blue, Low}. Similarly, the feature value subset for instance 6 in the calculation is {Blue, High}. The conditional probability ratio calculated for these feature value subsets across the two instances is shown as ¾ (or 75%).

The use of probability distance scores to quantify distances for categorical data is an improved approach to modeling categorical data whose intrinsic property is the lack of natural order between values of a particular category. Moreover, candidate input instances with low probability values may be eliminated from the input instance dataset at the outset.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

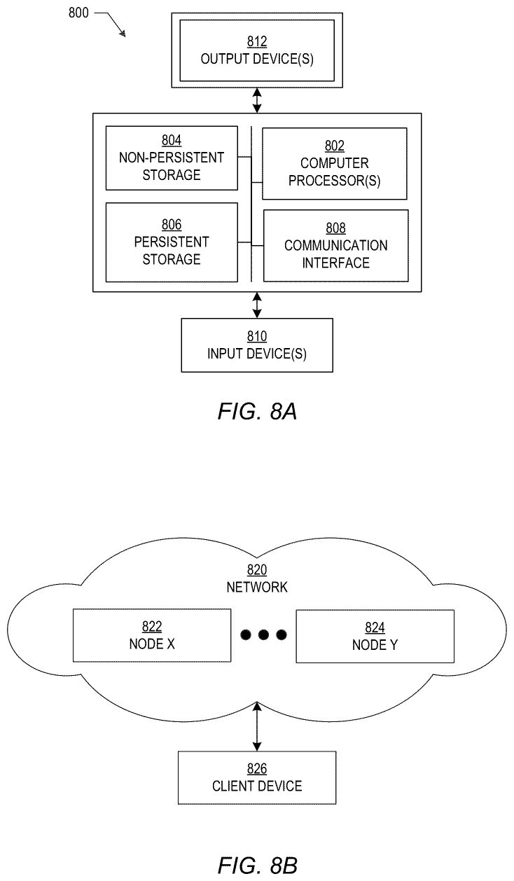

For example, as shown in FIG. 8A, the computing system (800) may include one or more computer processor(s) (802), non-persistent storage device(s) (804), persistent storage device(s) (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) (802) may be one or more cores or micro-cores of a processor. The computer processor(s) (802) includes one or more processors. The computer processor(s) (802) may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (812). The inputs may include text input, audio input, video input, etc., which may be processed and transmitted by the computing system (800) in accordance with one or more embodiments. The communication interface (808) may include an integrated circuit for connecting the computing system (800) to a network (not shown) (e.g., a local area network (LAN), a wide area network (WAN) such as the Internet, mobile network, or any other type of network) or to another device, such as another computing device, and combinations thereof.

Further, the output device(s) (812) may include a display device, a printer, external storage, or any other output device. One or more of the output devices may be the same or different from the input device(s) (810). The input and output device(s) may be locally or remotely connected to the computer processor(s) (802). Many distinct types of computing systems exist, and the aforementioned input and output device(s) may take other forms. The output device(s) (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (802), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8A. Further, the client device (826) may include or perform all or a portion of one or more embodiments.

The computing system of FIG. 8A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining, from an input instance dataset, a first input instance and a first class corresponding to the first input instance;
calculating, by a distance function generator executing on a computer processor, a probability distance score, based on a set of probability values, to transform the first input instance;
processing, by a counterfactuals generator executing on the computer processor, the first input instance and the probability distance score, to generate a counterfactual instance; and
executing a machine learning model, on the computer processor, to assign a second class to the counterfactual instance by processing the counterfactual instance, wherein the second class is different from the first class.

2. The method of claim 1, further comprising:
receiving the input instance dataset, wherein the input instance dataset comprises:
a plurality of input instances and corresponding classes, and
an input instance comprising feature values corresponding to feature categories;
extracting, by a feature extraction model executing on the computer processor, the feature categories from the input instance dataset to obtain a feature category set;
selecting a feature category from the feature category set;
selecting a feature category subset of a subset size from the feature category set, wherein the feature category subset comprises the feature category;
selecting a feature value subset corresponding to the feature category subset; and
calculating a probability value of an occurrence of the feature value subset in the input instance dataset to obtain the set of probability values.

3. The method of claim 1, wherein calculating the probability distance score based on the set of probability values, further comprises:
processing the set of probability values with a smoothing function to obtain a set of smoothed probability values;
selecting a second input instance from the input instance dataset;
selecting a first feature value subset from the first input instance, wherein the first feature value subset corresponds to a subset of first feature categories of a subset size;
selecting a second feature value subset from the second input instance, wherein the second feature value subset corresponds to the subset of first feature categories;
calculating a probability ratio of (i) a first probability value corresponding to the first feature value subset and (ii) a second probability value corresponding to the second feature value subset, wherein the first probability value and the second probability value are obtained from the set of smoothed probability values to obtain a set of probability ratios; and
calculating the probability distance score as a geometric mean of the set of probability ratios.

4. The method of claim 1, further comprising:
receiving a counterfactuals generation request with the input instance dataset; and
transmitting the counterfactual instance in response to the counterfactuals generation request.

5. The method of claim 1, wherein:
the counterfactuals generator comprises a second machine learning model trained to generate, as output, the counterfactual instance in response to an input comprising an input instance and the probability distance score.

6. The method of claim 1, further comprising:
screening the input instance dataset, comprising:
extracting, by a feature extraction model executing on the computer processor, feature categories from the input instance dataset to obtain a feature category set;
selecting a candidate input instance from the input instance dataset;
selecting a feature from the feature category set;
selecting a feature category subset of a subset size from the feature category set, wherein the feature category includes the selected feature;
selecting a candidate feature value subset from the candidate input instance corresponding to the feature categories of the feature category subset; and
calculating a probability value of an occurrence of the candidate feature value subset in the input instance dataset to obtain a set of candidate probability values.

7. The method of claim 6, further comprising:
processing the set of candidate probability values with a smoothing function to obtain a set of smoothed candidate probability values;
calculating an instance probability score as a geometric mean of the set of smoothed candidate probability values; and
removing the candidate input instance from the input instance dataset, responsive to the instance probability score being less than an instance score threshold.

8. A method comprising:
obtaining a first snapshot corresponding to a first timestamp and a second snapshot corresponding to a second timestamp of an input instance dataset from a data repository,
wherein the first timestamp is prior to the second timestamp, and
wherein the first snapshot and second snapshot are copies of the input instance dataset corresponding to the first timestamp and second timestamp respectively;
extracting, by a feature extraction model executing on a computer processor, feature categories from the input instance dataset to obtain a feature category set;
selecting a feature category subset of a subset size from the feature category set;
selecting a previous input instance from the first snapshot and a next input instance from the second snapshot;
selecting a previous feature value subset from the previous input instance and a next feature value subset from the next input instance, wherein the previous feature value subset and the next feature value subset correspond to the feature category subset;
calculating a previous probability value of an occurrence of the previous feature value subset in the first snapshot; and
calculating a next probability value of the occurrence of the next feature value subset in the second snapshot.

9. The method of claim 8, further comprising:
calculating a conditional probability as a ratio of (i) the previous probability value and (ii) the next probability value to obtain a set of conditional probabilities;
calculating a conditional probability distance score as a geometric mean of the set of conditional probabilities; and
processing, by a counterfactuals generator executing on the computer processor, the previous input instance and the conditional probability distance score to generate a counterfactual instance.

10. A system comprising:
a server computing system, comprising:
a computer processor;
a data repository,
a distance function generator, executing on the computer processor and communicatively coupled to the data repository, and
a counterfactuals generator, executing on the computer processor and communicatively coupled to the data repository,
wherein the server computing system is configured to:
obtain, from an input instance dataset, a first input instance and a first class corresponding to the first input instance;
calculate, by the distance function generator, a probability distance score, based on a set of probability values, to transform the first input instance;
process, by the counterfactuals generator, the first input instance and the probability distance score, to generate a counterfactual instance; and
execute a machine learning model on the computer processor to assign a second class to the counterfactual instance by processing the counterfactual instance, wherein the second class is different from the first class.

11. The system of claim 10, further comprising:
a feature extraction model, communicatively coupled to the data repository, which, when executing on the computer processor is configured to cause the computer processor to extract, from the input instance dataset comprising a plurality of input instances and corresponding classes, an input instance comprising feature values corresponding to feature categories,
wherein the feature categories from the input instance dataset to obtain a feature category set, and
wherein the server computing system is further configured to:
select a feature category from the feature category set,
select a feature category subset of a subset size from the feature category set, wherein the feature category subset comprises the feature category,
select a feature value subset corresponding to the feature category subset, and
calculate a probability value of an occurrence of the feature value subset in the input instance dataset to obtain the set of probability values.

12. The system of claim 10,
wherein the server computing system is further configured to:
select a second input instance from the input instance dataset,
select a first feature value subset from the first input instance, wherein the first feature value subset corresponds to a subset of first feature categories of a subset size, and
select a second feature value subset from the second input instance, wherein the second feature value subset corresponds to the subset of first feature categories, and
wherein the distance function generator executing on the computer processor is further configured to cause the computer processor to:
process the set of probability values with a smoothing function to obtain a set of smoothed probability values,
calculate a probability ratio of (i) a first probability value corresponding to the first feature value subset and (ii) a second probability value corresponding to the second feature value subset, wherein the first probability value and the second probability value are obtained from the set of smoothed probability values, to obtain a set of probability ratios, and
calculate the probability distance score as a geometric mean of the set of probability ratios.

13. The system of claim 10, wherein the server computing system is further configured to:
receive a counterfactuals generation request from a user computing system, and
transmit the counterfactual instance to the user computing system in response to the counterfactuals generation request.

14. The system of claim 10, wherein the server computing system is further configured to:
receive a counterfactuals generation request from a developer computing system, and
transmit the counterfactual instance to the developer computing system in response to the counterfactuals generation request.

15. The system of claim 10, wherein the counterfactuals generator comprises a second machine learning model trained to generate, as output, the counterfactual instance in response to an input comprising an input instance and the probability distance score.

16. The system of claim 10, wherein the server computing system is further configured to:
screen the input instance dataset by:
extracting, by a feature extraction model executing on the computer processor, feature categories from the input instance dataset to obtain a feature category set,
selecting a candidate input instance from the input instance dataset,
selecting a feature from the feature category set,
selecting a feature category subset of a subset size from the feature category set, wherein the feature category includes the selected feature,
selecting a candidate feature value subset from the candidate input instance corresponding to the feature categories of the feature category subset, and
calculating a probability value of an occurrence of the candidate feature value subset in the input instance dataset to obtain a set of candidate probability values.

17. The system of claim 16,
wherein the distance function generator executing on the computer processor is further configured to cause the computer processor to:
process the set of candidate probability values with a smoothing function to obtain a set of smoothed candidate probability values, and
calculate an instance probability score as a geometric mean of the set of smoothed candidate probability values, and
wherein the server computing system is further configured to remove the candidate input instance from the input instance dataset, responsive to the instance probability score being less than an instance score threshold.

18. The system of claim 10,
wherein the server computing system is further configured to:
obtain a first snapshot corresponding to a first timestamp and a second snapshot corresponding to a second timestamp of the input instance dataset from the data repository, wherein the first timestamp is prior to the second timestamp, wherein the first snapshot and second snapshot are copies of the input instance dataset corresponding to the first timestamp and second timestamp respectively,
extract, by a feature extraction model executing on the computer processor, feature categories from the input instance dataset to obtain a feature category set,
select a feature category subset of a subset size from the feature category set,
select a previous input instance from the first snapshot and a next input instance from the second snapshot, and
select a previous feature value subset from the previous input instance and a next feature value subset from the next input instance, wherein the previous feature value subset and the next feature value subset correspond to the feature category subset.

19. The system of claim 18, wherein the server computing system is further configured to:
calculate a previous probability value of an occurrence of the previous feature value subset in the first snapshot, and
calculate a next probability value of the occurrence of the next feature value subset in the second snapshot.

20. The system of claim 19,
wherein the distance function generator executing on the computer processor is further configured to cause the computer processor to:
calculate a conditional probability as a ratio of (i) the previous probability value and (ii) the next probability value to obtain a set of conditional probabilities, and
calculate a conditional probability distance score as a geometric mean of the set of conditional probabilities, and
wherein the counterfactuals generator executing on the computer processor is further configured to cause the computer processor to process the previous input instance and the conditional probability distance score to generate the counterfactual instance.
